(19) United States
(12) Patent Application Publication
(10) Pub. No.: US 2008/0256128 A1
(43) Pub. Date: Oct. 16, 2008

(54) Systems and methods for source document management in clinical trials

(75) Inventors: Douglas Edward Pierce, Pfafftown, NC (US); Thomas Willard Littlejohn, Winston-Salem, NC (US)

Correspondence Address: KILPATRICK STOCKTON LLP, 1001 WEST FOURTH STREET, WINSTON-SALEM, NC, 27101, US

(73) Assignee: Clinical Ink, LLC, Winston-Salem, NC (US)

(21) Appl. No.: 11/953,621

(22) Filed: Dec. 10, 2007

Related U.S. Application Data
(60) Provisional application No. 60/869,186, filed on Dec. 8, 2006.

(51) Int. Cl. G06F 17/30

(52) U.S. Cl. 707/104.1; 705/3; 707/E17.002

(57) ABSTRACT

System and methods for source documents management in clinical trials are described. One described method comprises receiving a clinical trial form on a client device over a network from a server device, the clinical trial form comprising a plurality of form data fields; receiving structured clinical trial data associated with at least one of the plurality of form data fields; receiving unstructured clinical trial data; and transmitting the structured clinical trial data and unstructured clinical trial data to the server over the network.

### CROSS-REFERENCE TO RELATED APPLICATIONS

This application claims priority to U.S. Provisional Patent Application Ser. No. 60/869,186, which was filed on Dec. 8, 2007 and titled, “Systems and Methods for Source Document Management in Clinical Trials,” the entirety of which is incorporated herein by reference.

### FIELD OF THE INVENTION

The present invention relates generally to clinical trial data collection. This invention more particularly relates to source document management in clinical trials.

### BACKGROUND

Traditionally, when data was collected in clinical trials, the collection was done with paper. The typical clinical trial begins with the sponsoring company, such as a medical device or pharmaceutical company, creating a protocol which defines the scope of the trial and defines what data is to be gathered and in what manner it is to be gathered. This process generates prodigious amounts of paper that have to be maintained in a secure manner.

Over the last several years, various applications have been marketed to facilitate the electronic capture of the data and the transmission of data to the sponsoring company's database and data management programs. Such systems generally either resided on a remote computer accessed via the Internet or on a computer at a research site.

The investigators, who gather the data in the clinical trial, enter the data on a paper form. This data is then entered into an electronic data capture (“EDC”) system. So the EDC software is designed for a specific trial, and the software captures the data points that the protocol says may be in it. The data, once captured, is then transmitted to data management systems and/or data analysis systems. Discrepancies in data are addressed by comparing the data to the paper stored at the research site. And much of the data that is captured on the paper form is never captured by the conventional EDC systems.

The conventional systems for collecting clinical trial data suffer from various problems. First, data entry occurs twice, which is inefficient and which may lead to errors. Second, since monitors have to compare the data to the source documents, which are typically stored at the research site, the monitors have to travel to the research site to perform the comparisons; this can be costly. In addition, the source documents must be maintained in an archive for fifteen years after the conclusion of the trial, further adding to the cost.

A need exists for systems and methods for creating and managing electronic source documentation in clinical trials.

### SUMMARY

Embodiments of the present invention provide systems and methods for source documents management in clinical trials. In one embodiment of the present invention, a method comprises receiving a clinical trial form on a client device over a network from a server device, the clinical trial form comprising a plurality of form data fields; receiving structured clinical trial data associated with at least one of the plurality of form data fields; receiving unstructured clinical trial data; and transmitting the structured clinical trial data and unstructured clinical trial data to the server over the network. In another embodiment, a computer-readable medium (such as, for example random access memory or a computer disk) comprises executable program code for carrying out such a method.

This illustrative embodiment is mentioned not to limit or define the invention, but to provide one example to aid understanding thereof. Illustrative embodiments are discussed in the Detailed Description, and further description of the invention is provided there. Advantages offered by the various embodiments of the present invention may be further understood by examining this specification.

### FIGURES

These and other features, aspects, and advantages of the present invention are better understood when the following Detailed Description is read with reference to the accompanying drawings, wherein:

FIG. 1 is a block illustrating an illustrative system architecture for one embodiment of the present invention;

FIG. 2 is a block diagram illustrating a database schema for a system in one embodiment of the present invention;

FIG. 3 is a flow chart illustrating a method of entering clinical trial data according to one embodiment of the present invention;

FIG. 4 is a flow chart illustrating a method of processing clinical trial data according to one embodiment of the present invention:

FIG. 5 is a screenshot of a Study Detail screen in one embodiment of the present invention;

FIG. 6 is a screenshot of a virtual chart room in one embodiment of the present invention;

FIG. 7 is a screenshot of an edit subject screen in one embodiment of the present invention;

FIG. 8 is a screenshot of a Form Data Entry screen in one embodiment of the present invention;

FIG. 9 is a screenshot of a visit preview screen in one embodiment of the present invention;

FIG. 10 is a screenshot of a visit detail screen, which allows the user to enter information regarding a current visit;

FIG. 11 is a screenshot of a form for entering an adverse effect for a subject in one embodiment of the present invention; and

FIG. 12 is a screenshot of a form for entering a concomitant medication in one embodiment of the present invention.

### DETAILED DESCRIPTION

### Introduction

Embodiments of the present invention comprise systems and methods for source documents management in clinical trials. One embodiment of the present invention is an electronic solution for source documentation management in clinical trials, employing the power of digital forms and tablet PCs. The system may be contracted by the sponsors to manage the source documentation process for research sites.

One such embodiment provides the ability to create electronic versions of the source documents, add verification rules that eliminate the majority of data entry errors, create a HIPAA and FDA compliant data trail of form data and ink strokes and allow for seamless transmission to the sponsor's EDC database or other backend system. One embodiment of the present invention includes an electronic case report form (“eCRF”) Interface. The eCRF Interface is a .NET service that runs in the background, synchronizing data collected in the system with the eCRF solution used by the sponsor. This component may adhere to the eCRF application programming interface (“API”) to communicate data interchange whether it is a web service call, a custom API or via the CDISC Standard for Exchange of Nonclinical Data (SEND) specification. Data that is submitted via the system tablets is inserted into a queue on the server's database. The eCRF Interface component polls this queue for activity, composes a message with the necessary data and guarantees delivery to the eCRF system. Transactions are logged to the system audit trail. Once the data has been successfully delivered to the eCRF, the data may be removed from the queue and flagged as complete.

In one embodiment, once a trial is configured and the documentation and business rules have been designed, the clinical trial form is made available on a server. An investigator at a research site conducting the trial uses the tablet PC to contact the server. In response the server provides the tablet PC with a digital clinical trial data form. The digital form enables the investigator at the research sites to capture the data electronically. The clinical trial form includes a plurality of fields, which the investigator fills in with structured data using pen-based data entry techniques, such as selecting from a list of options or performing handwriting recognition. The clinical trial form may also include unstructured data, such as annotations or a signature rendered in digital ink.

In the illustrative embodiment, once the form has been filled out, the tablet PC validates the form to ensure the data entered by the user is acceptable under the business rules designed for the clinical trial form. The form, including the structured and unstructured data, is then transmitted to the server.

Once the clinical trial form is on the server, a human-readable version of the clinical trial form is generated. For instance, a portable document format (pdf) that includes the structured and unstructured data may be created. The human-readable version of the form as well as the structured and unstructured data is made available to various parties, including, for example, the study monitor.

This illustrative example is given to introduce the reader to the general subject matter discussed herein. The invention is not limited to this example. The following sections describe various additional embodiments and examples of systems and methods for source document management in clinical trials.

### System Architecture

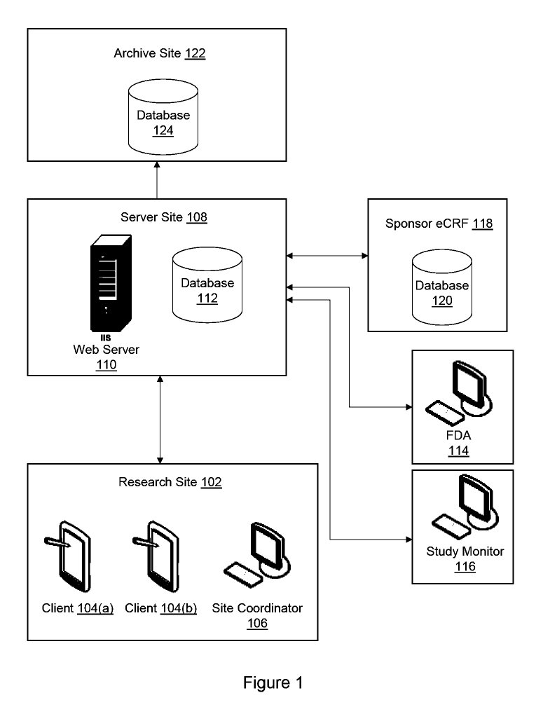

Various systems in accordance with the present invention may be constructed. FIG. 1 is a block illustrating illustrative system architecture for one embodiment of the present invention. In the embodiment shown, a research site 102 includes multiple client devices 104. In the embodiment shown in FIG. 1, the client devices are tablet devices 104a and 104b. The tablet devices are used by researchers or other users to enter data into, annotate, and sign clinical trial forms.

The research site 102 also includes a site coordinator client device 106, which is a desktop PC in the embodiment shown. The client device 104 and site coordinator PC 106 are connected to a network (not shown). The client devices 104 may be utilized in a partially-connected environment. In other words, they may be connected intermittently to, for example, synchronize with a server (synchronously or asynchronously), download forms, study data and software updates, upload completed forms, or perform other tasks that may require some type of connection.

The digital tablets 104 shown in FIG. 1 support handwriting recognition and digital ink. Each ink stroke and its associated properties (color, width, author, text translation, etc.) can be manipulated and stored just like traditional ASCII text. Digital ink may be utilized by an embodiment of this invention in various ways, including sketching, messaging, highlighting, program control (through the use of gestures), annotation, note-taking, text entry (e.g., through handwriting recognition), capturing signatures, and other activities.

Other types of client devices 104 may be utilized. Examples of client device are personal computers, digital assistants, personal digital assistants, cellular phones, mobile phones, smart phones, pagers, digital tablets, laptop computers, Internet appliances, and other processor-based devices. In general, a client device may be any suitable type of processor-based platform that can be connected to a network and allows for input via a pen-based interface.

The client device 104 contains a processor coupled to a computer readable medium, such as memory. Client device 104 may operate on any operating system capable of supporting a pen-based application according to an embodiment of the present invention, such as Microsoft® Windows® (e.g., Microsoft® Windows® XP Tablet Edition) or Linux.

In the embodiment shown in FIG. 1, the client devices 104 have a slate form factor. Vendors that support this style include Motion Computing, Electrovaya and Fujitsu. Examples of other suitable client devices 104 include, for example, convertible notebook computers.

The research site 102 is in communication with a server site 108. The communication link may be of any type suitable for transmitting information between the two sites. For instance, the communication link may include a wireless or wired connection or a dialup connection and may utilize private or public networks, such as the Internet. Communication may occur using any standard protocol or format, including, for example, hypertext transfer protocol (“HTTP”), hypertext markup language (“HTML”), and eXtensible Markup Language (“XML”). Because of the nature of the data being transferred between the various servers, much of the communication between servers is encrypted or otherwise secured. Some embodiments of the present invention include components for interfacing with third-party solutions (e.g., lab, ECG/EKG, and eCRF solutions). For instance, data may be passed to backend systems, such as clinical trial management or clinical trial data systems.

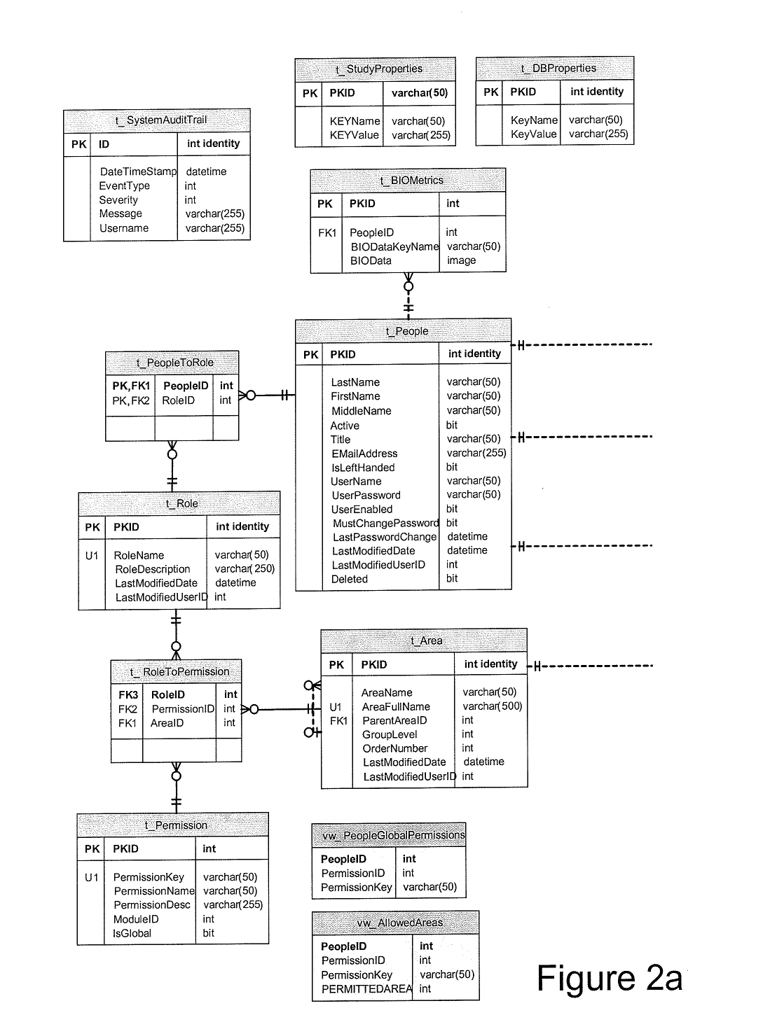

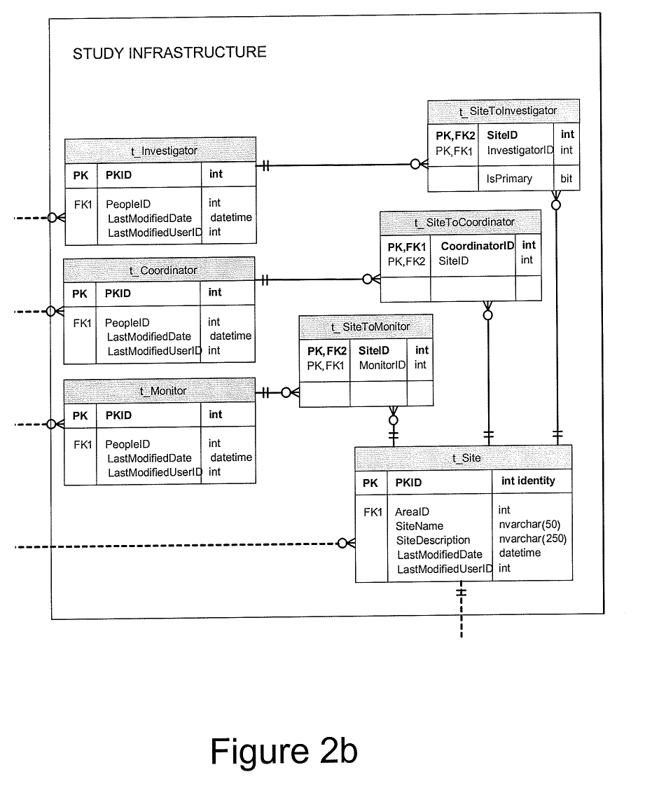

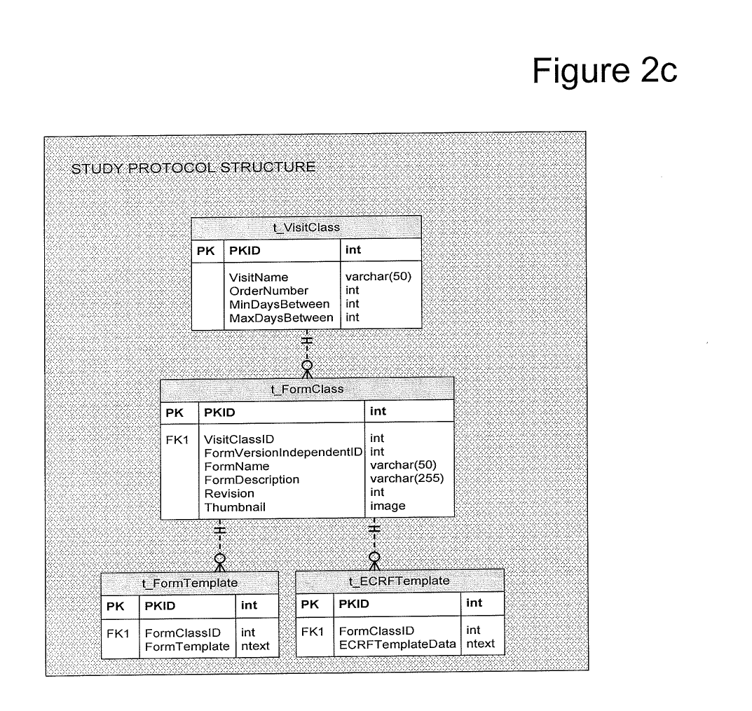

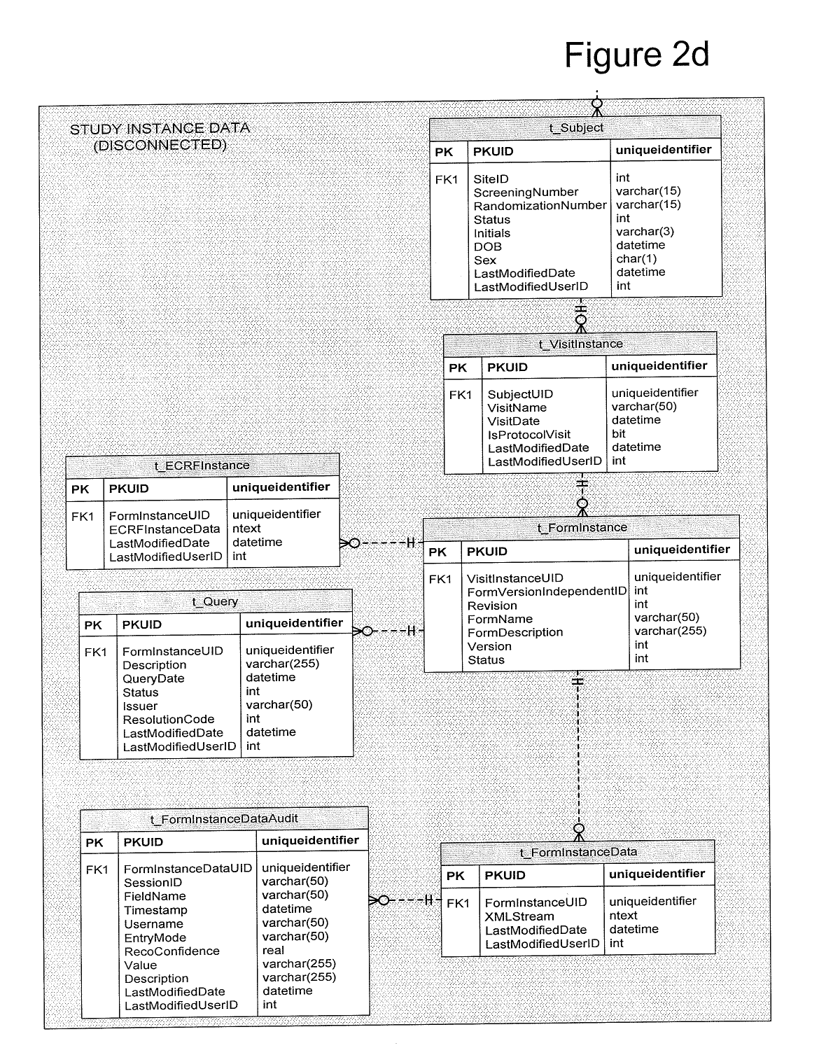

The server site 108 includes various servers and applications. In the embodiment shown, the server site 108 includes a web server 110. The web server 110 receives requests from various devices, including client devices 104 and performs actions based on those requests. For instance, if the web server 110 receives a request for a clinical trial form from a client 104(a), the web server 110 responds with the form. In the embodiment shown, the web server 110 executes Microsoft's Internet Information Server (“IIS”). In other embodiments, other types of servers may be used, including, for example, the Apache web server. The server site 108 also includes a database server 112. The database server 112 stores data utilized by the web server 110 in processing requests. In the embodiment shown, the database server is a Microsoft SQL Server relational database. A single database server or server cluster may be scalable and designed to support the collection of data for clinical trials. Embodiments of the present invention may be designed for global use. In such embodiments, the forms may support multiple languages and synchronization over varying communications infrastructures worldwide (e.g., low-bandwidth connections). The database schema in such embodiments could, for example, store double-byte character sets. FIG. 2 is a block diagram illustrating a database schema for a system in one embodiment of the present invention.

One or more database servers may be utilized for storing the system data, including, for example, protocol definition, forms, clinical data, security and audit trail. In one embodiment of the present invention, the server database 112 supports a multi-tenant, ASP model and an enterprise security model (accounts/sites/groups/roles/areas/users). The database may also support the storage of: study configuration data including the number of visits for the study, the time between visits and the forms that need to be completed each visit; form templates, revisions, validation rules and custom script; research site session data/patient records including data collected, form images, original ink, electronic signature and audit trail; and archived patient records after data lock for retrieval by a research site at a later date.

The database may store a universal data set that will hold data from a plurality of studies. The database schema may be based, at least in part, on a schema provided by a sponsor or EDC vendor. Such a schema design may allow data to be more easily shared.

In some embodiments, there may be a database on the clients 104 (“client database”) for caching information in addition to the database 112 (“server database”). An application on the client or the client database itself may be responsible for synchronizing the two databases. The client database may be built on the same technology as the server database 112 to ease integration. In some embodiments, the client and server database are different technologies, and a bridge between the two is utilized to ease data synchronization. In one embodiment of the present invention, the user is able to restore the client database to its original state. This may be done via a simple file copy or a restore of a backup. A utility may be provided to return to the restore point.

Referring still to FIG. 1, the server site 108 is also in communication with various other sites. For instance, in the embodiments shown, data or clinical trial forms from a clinical trial or other information may be provided to the Food and Drug Administration (FDA) 114 or to a study monitor 116. Information may also be exchanged between the server site 108 and a study sponsor or contract research organization's (“CRO”) EDC system 118 and the database 120 supporting the EDC application. For instance, in one embodiment, a backend process manages the synchronization of data between the server site database 112 and the EDC database 120.

The server site 108 is also in communication with an archive site 122. The archive site 122 includes a database 124, which may include archived data from the server site's database 112.

Various reports may be made available in embodiments of the present invention. For instance, in one embodiment, a study investigator or monitor is able to view multiple patient

The client and server devices described above contain one or more processors coupled to or in communication with a computer-readable medium, such as memory. The memory comprises applications, such as the web server or clinical trial form software. Client and server devices, which are depicted as single computer systems, may be implemented as a network of computer processors. Examples of server devices are a server, mainframe computer, networked computer, or other processor-based devices, and similar types of systems and devices.

Client processors and server processors can be any of a number of computer processors, such as processors from Intel Corporation of Santa Clara, Calif. and Motorola Corporation of Schaumburg, Ill. Such processors may include a microprocessor, an ASIC, and state machines. Such processors include, or may be in communication with computer-readable media, which stores program code or instructions that, when executed by the processor, cause the processor to perform actions. Embodiments of computer-readable media include, but are not limited to, an electronic, optical, magnetic, or other storage or transmission device capable of providing a processor, such as the processor of server device, with computer-readable instructions. Other examples of suitable media include, but are not limited to, a floppy disk, CDROM, DVD, magnetic disk, memory chip, ROM, RAM, an ASIC, a configured processor, optical media, magnetic tape media, or any other suitable medium from which a computer processor can read instructions. Also, various other devices capable of transmitting or carrying program code or instructions to a computer, including a router, private or public network, or other transmission device or channel, both wired and wireless, may comprise various forms of computer-readable media. The instructions may comprise program code from any computer-programming language, including, for example, C, C++, C#, Visual Basic, Java, Python, Perl, and JavaScript.

It should be noted that the present invention may comprise systems having a different architecture than that which is shown in FIG. 1.

### System Administration

Embodiments of the present invention may comprise a variety of system administration components. The system administration components may be, for example, resident on the web server 110 and accessed by the study monitor 116. In one embodiment, the system administration features are divided into functional elements, such as the following categories or subject areas: System, Study Infrastructure, Study Protocol and Study Instance Data. Other embodiments may be divided differently.

System administration may include functions, such as setting up a study, creating forms, defining security (e.g., roles assigned to users), determining audit trail criteria, and managing biometric data.

### Forms Designer

One embodiment of the present invention provides a Form Designer. The Form Designer is a desktop client for designing forms for the study as well as building custom validation rules. It provides the following functionality: support for quickly converting existing paper forms by OCR or electronic forms such as Word and PDF; support for content-rich forms with rich text, text and numeric fields, custom pick-lists, checkboxes, radio buttons, images, freeform ink, diagram and drawing annotation and electronic signature; support for prefilling a form from a standard database; support for outputting form images, collected data and original ink strokes to standard interfaces such as database and PDF; and support for building complex business rules that validate information entered and determine required fields.

In one embodiment of the present invention, a system according to the present invention utilizes the Mi-Forms Designer for designing electronic forms and building custom validation rules that reduce queries and data collection errors. In other embodiments, a custom form designer may be implemented. In yet another embodiment, an automated form designer utilizes an electronic version of a protocol and creates a form based on the protocol. A developer may then modify the generated form to customize aspects, such as the validation rules.

### Study Configuration Tool

One embodiment of the present invention provides a tool that allows for the creation of a study configuration file. This includes defining the characteristics of a study: the number of visits, the time between visits, required data fields and the forms that may be completed per visit. This tool may also be responsible for mapping out the database schema for the study so that data can be automatically exported to the EDC database. A mapping may be created for each form in the study from the form field to the database fields. Validation rules may be created for each form. All of this information may be created per the protocol specifications and exported to a configuration file that can be used by the tablet PC smart-client. In order to speed up the study modeling process and support industry standards, this tool may support importing Operational Data Modeling (ODM) v1.2.1 schemas which define the study model.

### Protocol Configuration Workflow Summary

One embodiment of the present invention provides a method for configuring a protocol. First, the user is prompted to import ODM schema or have user specify protocol information (study name/description, visit names/timeframe, required fields). The user then browses for Mi-Forms form templates. The user may have the ability to map fields from Mi-Form template to required fields (database schema for EDC). The user then saves the configuration.

The Tool generates dynamic database schema for this study and builds catalog in server database 112 (e.g., “Study Merck 123”). In one embodiment, a custom .NET assembly may be generated and distributed with the forms to act as an adapter for the business intelligence and communication with the system backend. This will allow validation to be performed at the client and for customized data mapping/extraction on a study-by-study basis. This will also provide for a standard interface for saving form session data, form revisions and electronic paper trail.

### Adaptive Design

To support an Adaptive Design methodology in the system, in some embodiments, the software may provide mechanisms for changes to the study as it proceeds. These modifications include form edits, new or improved validation rules and changes to the forms that make up a visit. Versions may be maintained on the study configuration file and form templates and published with effective dates so that the system administrators can control distribution.

### Web Site

In one embodiment of the present invention, the system web site is the home for all clinical trial data management. One such site includes both a standard web browser interface and a web services interface. The web browser interface is for managing the study, security, monitoring the study, and viewing audit trail. The web services interface is to support synchronization between the site and the smart clients running on the tablets. It is also designed to facilitate seamless data interchange with the EDC system used by the sponsor. In one embodiment, the web site runs on an IIS server with a SQL Server 2005 database backend. Web browser communication with the server may be done via a secure sockets layer (“SSL”) connection over hypertext transfer protocol/secure (“HTTPS”). The web services may accept incoming synchronization requests from both the tablet smart clients as well as the sponsor's EDC. Communication with the various EDC systems may be accomplished by using industry standard and vendor provided interfaces. In one embodiment, a background service monitors inbound synchronization requests from the tablets and keeps the EDC system in synch.

### Illustrative Methods

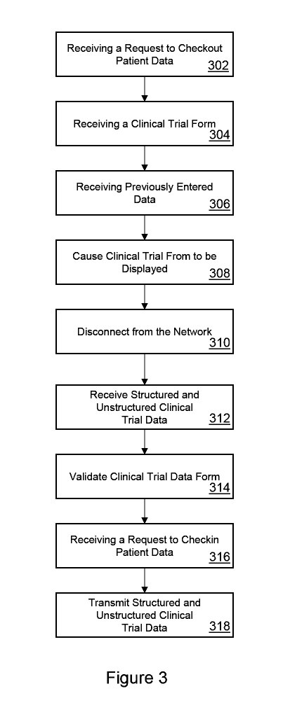

Various methods may be implemented in embodiments of the present invention. FIG. 3 is a flow chart illustrating a method of entering clinical trial data according to one embodiment of the present invention. In the method shown in FIG. 3, a user utilizes a user interface on a client device 104 to request a clinical trial form with previously-entered patient data. The client device 104 receives the request 302. For instance, the user may perform a search for a particular patient and then click a “checkout” button.

In response, the client device 104 sends a request to a server, such as web server 110, and in response to the request, receives a clinical trial form 304. The clinical trial form includes a plurality of fields that are defined in a form designer and may also include validation rules or business rules related to the entry of data on the form.

In the embodiment shown in FIG. 3, the user also receives previously-entered data associated with the patient the user is interested in 306. For instance, the user may receive data regarding past visits for a particular patient. This data can be used during a current visit for comparison purposes. The client device 104 may also receive data regarding future visits so that the patient can be prepared for any prerequisites of a future visit. For instance, the patient may be instructed to fast for twelve hours before the next visit.

Once the client device 104 has received the form and the data, the client device causes the clinical trial form to be displayed 308. The previously entered data may include both structured data, such as form field values, and unstructured data, such as an annotation or signature. Thus, the client device 104 must accurately present the data with the form. In some cases, the client device 104 may display a form without any previously entered data, such as when a visit is a patient's first visit.

In some embodiments, the client device 104 may operate in a connected state or in a disconnected state. In the embodiment shown in FIG. 3, once the client device 104 receives the form and the data, the client device 104 disconnects from the network 310. Disconnecting from the network may be preferable for conserving network resources. In some cases, a network may not be available when the data entry occurs. For instance, if a clinical trial occurs in a rural area with data connectivity, the client device may have to function in a disconnected state.

The user then begins entering data. In the embodiment shown, the user uses a pen-based operating system to enter data and is thus able to enter both structured and unstructured data. The client device 104 receives this clinical trial data 312.

The client device 104 then validates the clinical trial data form 314. Validation may be done when the form is complete, on a field-by-field basis, on a page-by-page basis, automatically based on some other criterion, or manually in response to a user's command.

Once the data has been validated, the user can check in the data. The client device 104 receives a request to checkin the patient data 316. In response the client device 104 transmits the structured and unstructured data to the web server 110.

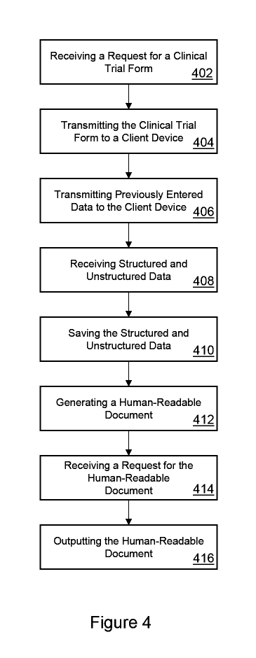

FIG. 4 is a flow chart illustrating a method of processing clinical trial data according to one embodiment of the present invention. In the embodiment shown in FIG. 4, the web server 110 receives a request for a clinical trial form 402. In one embodiment, the clinical trial form was created by a user based on a protocol from a study sponsor.

In response to the request, the web server 110 transmits the clinical trial form to a client device 104 via a network 404. The clinical trial form includes a plurality of form fields, validation rules, and other elements useful for editing clinical trial data. If the request includes a request to check-out an existing patient's information, the server 110 also transmits previously entered data to the client device 406.

A user on the client device 104 then fills out the form, entering new data or revising existing data. The user then submits the data to the server 110. The server 110 receives the structured and unstructured data entered by the user 410. The server 110 saves the data in the database 112.

In the embodiment shown in FIG. 4, the server 110 also automatically generates a electronic human-readable document comprising the clinical trial form, the structured data, and the unstructured data 412. The combination of these elements appears similar to a manually-created clinical trial form with annotations and a signature written on it by a user. This electronic document can be treated as a source document in lieu of a paper document.

The server 110 subsequently receives a request for the human-readable document or other data 414. In response, the server 110 provides the human-readable document 416. In another embodiment, the web server receives a request for the clinical trial form and constructs an HTML page that appears substantially identical to a paper clinical trial form. In yet another embodiment, various reports summarizing or detailing clinical trial information for one or more patients over one or more visits is provided in response to a request.

### User Interface

Various user interfaces may be utilized by embodiments of the present invention. The interfaces described herein are merely illustrative. In one embodiment of the present invention, the client device 104 comprises a smart client. The smart client is installed on client device 104 and accessed at a research site using the system. This smart client provides a means for collecting clinical data from each patient visit using electronic forms and for synchronizing that information with the web site.

The smart client may be implemented, for example, as a Microsoft .NET WinForms application. The client may use utilize the Mi-Forms SDK for forms-based data collection via natural handwriting. Such an embodiment uses the SDK to load predefined Mi-Forms templates. The Mi-Forms platform can also provide powerful validation rules and custom scripting capabilities. Communication with the web server 110 may occur via secure web services calls.

In one embodiment, each smart client caches data in a local SQL Server 2005 Everywhere database (not shown). The client's synchronization engine manages downloading form updates, updating the study protocol, study data, and software, as well as uploading collected form data. In one embodiment, the smart client displays the study name and a progress indicator for the actively selected patient, basic patient information including initials, screening/subject ID, date of birth, sex and status. One such embodiment also includes a graphical or hierarchical view that is organized by visit (e.g., Visit −6, Visit −3, Visit 0, etc.) and includes folders of forms required for each visit. The client may utilize visual cues like color and icons to indicate completed visits/forms, forms that have queries generated against them, form completion percentage and patient status (e.g., screening, randomized, dropout, etc). The client may also include the ability to “explode” any form by double-clicking it so that the form filling operations maximize the available screen real estate as well as the ability to “collapse” the form to return back to the visit or study overview

One embodiment of the present invention prompts user for logon either via biometric fingerprint or standard username/password. Once the user has successfully logged in, the application supports the ability to view/search a list of participating subjects to start a visit. The search feature supports both subject/screening ID and initials. Such an embodiment may support working with a single patient record at a time or multiple patent records.

In one embodiment, the user interface presents forms to a user to be filled on the tablet and maximizes screen space while still allowing the user to return to the study overview. The user interface also allows the user to select and complete multiple, multi-page forms. The forms may belong to a particular visitor may be generic such, as Cumulative ConMed or Adverse Events. One embodiment prefills the forms with previous visit information or data preloaded for the study. And the forms may include different security permissions by, for example, only allowing the researcher to complete the Physical Exam page of the visit form.

One embodiment of the present invention provides support for validation rules that reduce the number of queries and compliance calculation for the forms—validation in one such embodiment is done as each page is completed. For example, a form may color highlight required fields, fields that don't pass validation or fields that have queries against them. The form may also provide a Submit button for synchronizing captured data with the server. One embodiment provides a Submit Incomplete and a Submit Complete feature so that forms can be submitted to the CRF in an incomplete status.

In one embodiment of the present invention, the user interface tracks all interactions with the form in time-stamped audit trail including timestamp, user, edits made and electronic paper trail of form revisions.

Another embodiment provides a mode that simulates how data could be automatically sent to an EDC system, such as an eCRF solution; for instance, the embodiment may export the data to CSV or XML and form images to PDF.

One embodiment of the present invention supports adding Unscheduled Visits. This includes providing a name for the visit and selecting a visit to copy. The Unscheduled Visit may be placed into the study hierarchy in the order defined by the date/timestamp. Such an embodiment may prevent users from proceeding to a future visit without completing or explicitly bypassing a scheduled visit. If the subject misses a visit, a reason code may be provided by the Coordinator.

In one embodiment of the present invention, a login dialog appears as the user starts the system. One such system supports two modes of login: (1) username/password and (2) biometric login with a built-in fingerprint sensor on a tablet. In one embodiment supporting the latter mode, the Authentec SDK may be used to communicate with the fingerprint reader. In one embodiment, no user authentication is done on the client device. In such an embodiment, the user enrollment and fingerprint scanning are done via a web portal prior to logging in to the application on the client device 104. In other embodiments, the user interface supports user authentication capabilities on the client device 104.

In one embodiment, each user has a home page which is the initial view for the application and provides a jump page for other activities. Activities include the coordinator's visit schedule for that particular day as well as active queries, past due visits, studies and diagnostic information (e.g., software version, last synchronized time, etc.).

### Study Detail

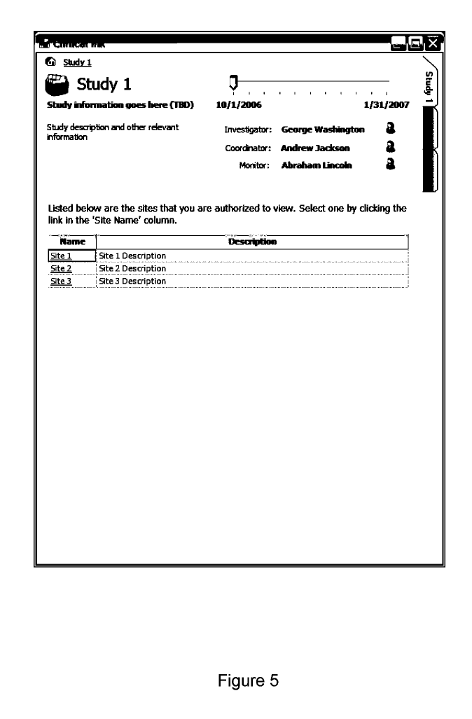

In one embodiment, a Study Detail page lists the studies that the user is authorized to see as a series of tabs. The user selects a tab for a study they are interested in and views the details of the study. Details may include such information as the sites that the user is authorized to see, the study name/description, progress indicator and investigator/coordinator/monitor assigned to the study. Each user may be authorized for at least one site. In one embodiment, a site represents a geographic location (e.g., Winston-Salem, N.C.). Other breakdowns for site may be utilized. FIG. 5 is a screenshot of a Study Detail screen in one embodiment of the present invention.

### Site Detail

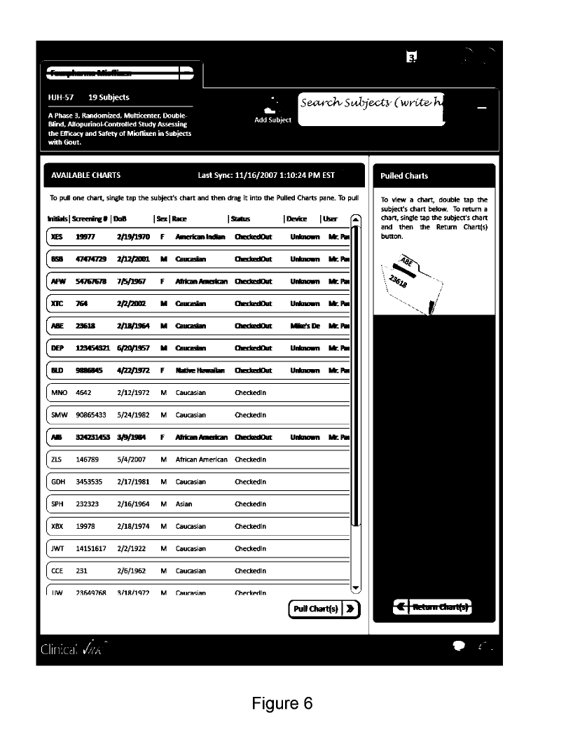

In the embodiment shown, by drilling down on the Study Detail screen, the user can see the details for a specific site. The Site Detail screen displays the site name/description and a list of the participating subjects. In one embodiment, the subject list displays the subject's initials, ID, status, DOB, gender, race, next visit name and next visit appointment or appointment range. The user may click the link of the subject's initials to navigate to the Subject Detail page. In another embodiment, the user enters a virtual chart room in order to view various subjects in a trial. FIG. 6 is a screenshot of a virtual chart room in one embodiment of the present invention. The status of the chart and some information regarding the subject are listed in each for each of the virtual charts shown. A user can click on a particular chart to see details for a subject within a clinical trial.

### Subject Detail

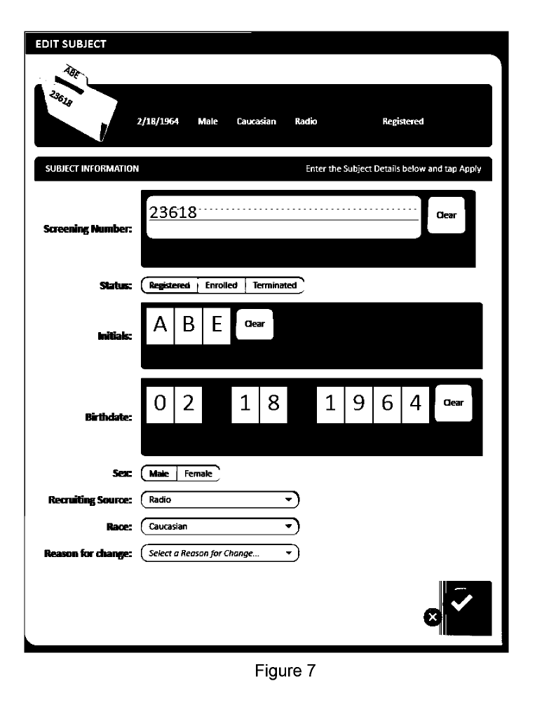

FIG. 7 is a screenshot of an edit subject screen in one embodiment of the present invention. In the embodiment shown, the user enters a screening number to identify the subject, and information about the subject, including initials, birth date, screening source, race, and if a change occurs, a reason for change to be stored in the audit trail.

FIG. 8 is a screenshot of a Subject Detail screen in one embodiment of the present invention. The Subject Detail screen shown displays information on the participating patient. General information about the subject is listed at the top of the page, including information such as screening/subject ID, date of birth, gender, race, status, and recruiting source. The list at the bottom represents the visits the subject has made for this study. The list provides the visit/form name, the scheduled date, and the date the visit occurred on. One embodiment includes a progress indicator for the study completion for the subject.

This page may be used as a launching point for completing forms. Clicking a visit or form link, the user is taken to the Form Data Entry screen with the protocol-specified forms loaded. If this is an unscheduled visit, the user may create a new unscheduled visit by clicking the “Add unscheduled visit . . . ” button. Unscheduled visits are automatically inserted into the visit schedule based on chronological order. They are automatically assigned a name based on the preceding visit. For example, if the preceding visit was Visit 3, the name would be “Visit 3.1”. If the preceding visit was Visit 3.1, the name would be “Visit 3.2”. A master Unscheduled Visit form may be included with each study so this may be used as the template for any new visits.

### Form Data Entry

Embodiments of the present invention include various forms for performing data entry. The Form Data Entry screens are used to complete the clinical forms. These screens may run in full screen mode to give the illusion of filling in a form rather than running a software application. Users may write anywhere in this area and complete the forms using the tablet stylus.

In some embodiments, there are also hotspot controls on the form. These are used to navigate between pages of a form. They are alpha blended on top of the form controls so you can still see any text that might be beneath them. When the user hovers over the page name may be displayed in a tooltip. The current page in total pages may also be displayed on the bottom of the form. The tabs section may display a tab for each form in the visit and can be used to navigate to a different form. The following tabs are displayed: Visit (e.g., “Visit 3”), AEs—represents the Cumulative Adverse Events form, ConMed—represents the Cumulative Concomitant Medications form, Drug Accountability—represents the Drug Accountability form, and Scheduling—represent the form for scheduling the next visit appointment.

Different colors can be used to indicate different meaning in the application. For example, a red tab could be used to indicate a form that has a query against it. The tab area will expand to fit all available space minus whatever the toolbar requires. Therefore, the client may implement a scrolling set of tabs.

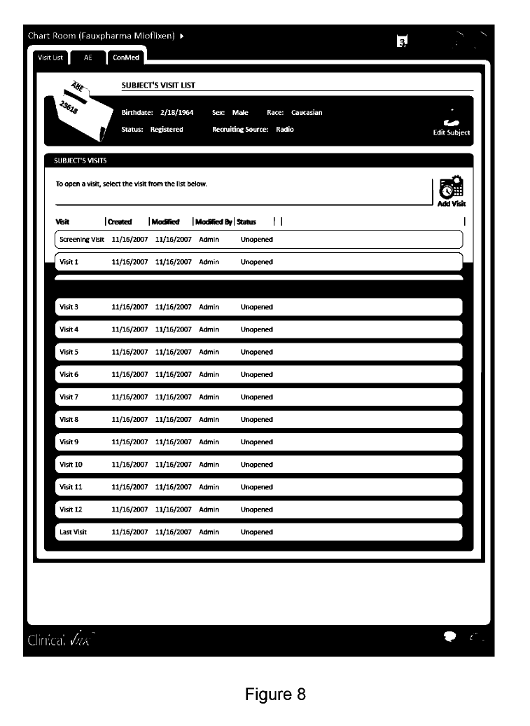

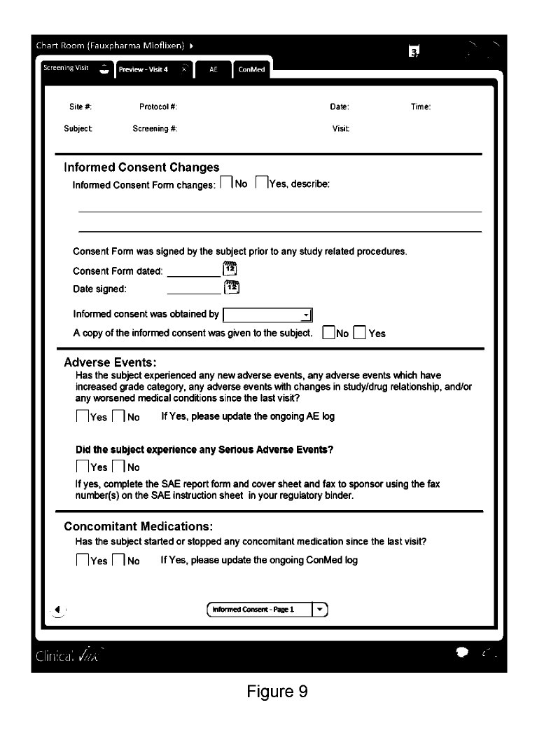

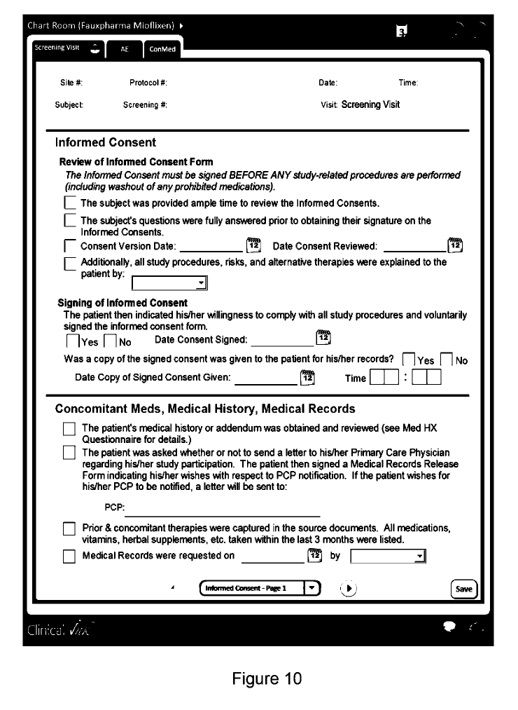

FIG. 9 is a screenshot of a visit preview screen in one embodiment of the present invention. In the embodiment shown, the user is able to preview the information necessary for the subject's next visit. FIG. 10 is a screenshot of a visit detail screen, which allows the user to enter information regarding a current visit.

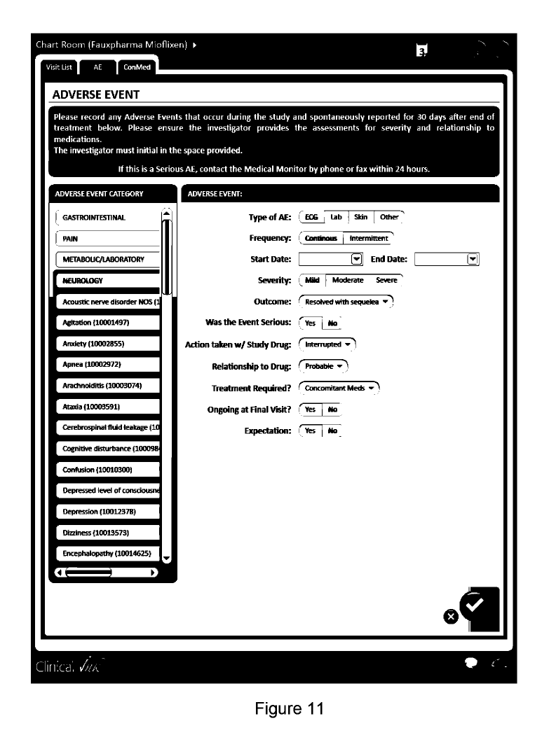

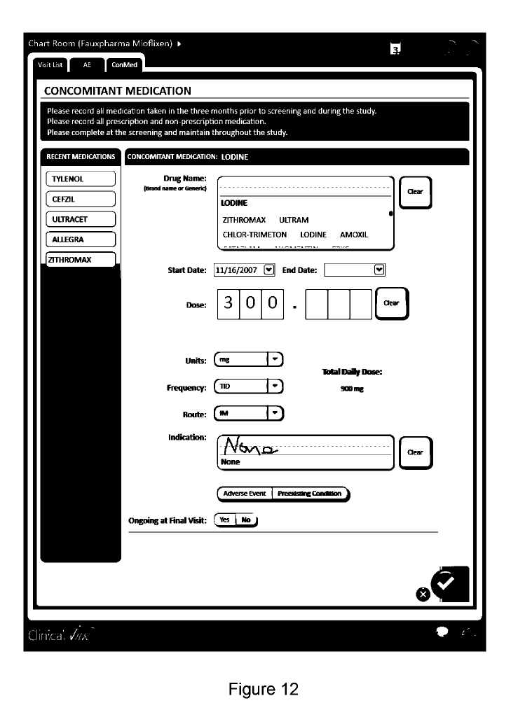

Various other types of information may also be entered by a user for a particular trial. FIG. 11 is a screenshot of a form for entering an adverse effect for a subject in one embodiment of the present invention. FIG. 12 is a screenshot of a form for entering a concomitant medication in one embodiment of the present invention.

### Form Data Adapter

One embodiment of the present invention includes a Form Data Adapter. The Form Data Adapter is a component that standardizes the way Mi-Forms templates perform validation, extract session data and audit trail information and communicate with the database. This component is designed to reduce the amount of custom script needed per form and help drive the cost of study setup down.

A custom, sponsor protocol-specific .NET assembly may be generated and used by all forms for validation, retrieving and saving session data, saving audit trail information and any customization. This reduces the amount of duplicate form custom script, expedite trial setup and make support of different sponsor database schemas/backends much more streamlined. This component may be auto-generated by the Study Configuration Tool

### IFormDataAdapter Interface

Another embodiment of the present invention includes an IFormDataAdapter interface. The IFormDataAdapter interface provides a standard interface for the Form Data Adapter assemblies. This assembly uses the business layer on the client to communicate with the database. In one embodiment, the user interface includes a routine for initialization of the form, including setting default values and highlighting fields that are required or have queries against them. Other embodiments include routines for validating the data and creating an audit trail for recording user activity within particular forms (e.g., “User bjones edited Medical History form”).

In some embodiments of the present invention, common dialogs are utilized for various tasks. For instance, one embodiment includes a PDR Drug Selection Dialog. This dialog is used to select a drug from the Physician's Desk Reference (PDR) database distributed to each client. Because drugs can be selected based on categories and search criteria, this may be abstracted to a user-friendly dialog. The form will have a dynamic label for drug name, dosage and units and provide a hyperlink for selecting/edit these values the local PDR database.

### Web Portal

One embodiment of the present invention provides a web portal. The web portal may serve a variety of purposes. It may be the main web portal for monitors as they use the site to review submitted form images and communicate with coordinators about queries. Research Site administrators may use the site to administer security for their users including assigning userids/passwords and defining security roles and permissions. Research Sites may use the portal to view archived eSource documentation. Lastly, the portal may be used by users to setup/manage studies/sites, view the system audit trail to monitor server performance/metrics and archive study documentation.

In one embodiment, the web portal provides the following internal administrative features: Study Management (publish study configurations and form templates); Site Management (add/remove/suspend sites); Security Management (accounts/areas/sites/groups/roles/areas/users and passwords); Database Management (import/export/reports/backup/restore); and Software License Management—it may be important to track Logical Ink licensing as well as Mi-Forms licensing which is done on a per tablet model and renewed annually.

The web portal may present a similar user interface layout to the tablet smart-client with regards to study management. However, data entry or form edits may or may not be available via the web. In embodiments of the present invention, the web portal may provide the following functionality:

One embodiment provides support for selecting a study, site, subject, visit and/or form and getting an overview at each page. For a study, a user may see a list of sites, for a site, a list of patients, for a patient, a list of visits, for a visit you'd see a list of forms, for a form, a revision history and an audit trail. Each page will may include visual cues which indicate the progress made or the status of that object (e.g., Visit completed). A chart/form metaphor would be used here when displaying the forms of a selected visit. The page may display information on a particular subject including form images and audit trail which allows the monitor to verify data collected.

The web portal may also provide a message center so that coordinators and monitors can exchange simple messages on a particular subject. The user interface may provide input for recipient, subject and message text when creating messages and allow users to view/reply to their messages.

One embodiment provides access to historical data such as participant's electronic patient chart during and after a study. Access to historical data after completion of the trial may include downloading a PDF of the entire chart for a selected subject or selected subjects.

One embodiment includes a home page. This is the main jump page for the web site. Based on the user's security profile, a list of actions that can be performed is displayed. For Coordinators and Monitors, this page lists the studies that they are allowed to see by study name and description.

One embodiment includes a Study Detail screen, which displays a summary of the study including name, description and participating sites. One embodiment also includes a Site Detail screen, which is displayed when the user clicks on a site hyperlink from the Study Detail page. It displays information for the site including name, the investigator, coordinator and monitor assigned to the site, and a list of subjects that are participating.

A Subject Detail screen may be displayed when a user clicks on the subject hyperlink on the Site Detail screen. This page displays a summary of information on the subject including initials, screening/subject ID, data of birth, sex, gender and status. It also displays a list of visits/forms, their status and the overall progress of the subject in the study. The user may click on any visit/form to navigate to the Form Detail screen and view the “electronic paper” audit trail.

A Form Detail page may be displayed. The Form Detail page is used to review submitted form information including form revisions, form data and audit trail. This page displays a list of form revisions and the user that made that revision. If the user selects a revision, they are presented with a PDF image of the form as well as a grid view of field names/values for that revision. These fields will link directly to EDC system fields required by the protocol.

### Compliance

Some embodiments of the present invention are compliant with some or all of both HIPAA and FDA 21 CFR Part 11 regulations. FDA Title 21 CFR Part 11 was published in 1997 and covers all aspects of electronic records including signatures, integrity and authenticity, record creation, audit trails and archiving. Part 11 requires electronic records that are “created, modified, maintained, archived, retrieved, or transmitted, under any records requirement set forth in agency regulations” may be protected by procedures and controls to “ensure the authenticity, integrity, and, when appropriate, the confidentiality of electronic records, and to ensure that the signer cannot readily repudiate the document as not genuine.” The goal of Part 11 is to ensure electronic records and signatures are at least as authentic and traceable as those on paper. Without the rule, accidental or deliberate tampering with electronic data about drugs could be difficult to monitor.

### General

Because the data is originally captured digitally, the electronic forms in embodiments of the present invention become the source documents and paper forms are reduced if not eliminated. In conventional systems, the sponsor sends monitors to all the research sites to verify that there is no discrepancy between the paper source document and the digital data. The monitoring process accounts for a large portion of the expense associated with a clinical trial. The system reduces and may eliminate the need for monitors to compare source documents with the CRF data. Documentation and “electronic paper” images are available via a web portal; therefore travel to the research sites is greatly reduced.

Embodiments of the present invention may also allow sponsors to cut training time, reduce errors, streamline the enrollment process and drastically reduce the need for monitors. The combination of these benefits results in significant reduction of costs for the sponsoring pharmaceutical company or CRO. Moreover, the illustrative system offers archival services to the research sites that enables them to store their data offsite in secure servers, allowing them instant access to the data from anywhere in the world and freeing them from the trouble and expense of physical storage facilities.

The foregoing description of the embodiments of the invention has been presented only for the purpose of illustration and description and is not intended to be exhaustive or to limit the invention to the precise forms disclosed. Numerous modifications and adaptations thereof may be apparent to those skilled in the art without departing from the spirit and scope of the present invention.

That which is claimed:

1. A method comprising:
receiving a clinical trial form on a client device over a network from a server device, the clinical trial form comprising a plurality of form data fields;
receiving structured clinical trial data associated with at least one of the plurality of form data fields;
receiving unstructured clinical trial data; and
transmitting the structured clinical trial data and unstructured clinical trial data to the server over the network.

2. The method of claim 1, wherein the unstructured clinical trial data comprises digital ink.

3. The method of claim 1, wherein the unstructured clinical trial data comprises at least one of a signature or an annotation.

4. The method of claim 1, wherein the client device comprises a tablet PC.

5. The method of claim 1, wherein receiving structured clinical trial data further comprises converting the unstructured clinical trial data to structured clinical trial data.

6. The method of claim 1, further comprising:
receiving a request to check out previously entered structured and unstructured data associated with a patient; and
causing the previously entered structured and unstructured clinical trial data to be displayed with the clinical trial form.

7. The method of claim 1, further comprising validating the structured clinical trial data before transmitting it to the server.

8. The method of claim 1, further comprising validating the structured clinical trial data before transmitting it to the server.

9. The method of claim 1, further comprising:
disconnecting from the network after receiving the clinical trial form; and
reconnecting to the network before transmitting the structured clinical trial data and unstructured clinical trial data to the server.

10. A computer-readable medium on which is encoded processor-executable program code, the computer-readable medium comprising:
program code for receiving a clinical trial form on a client device over a network from a server device, the clinical trial form comprising a plurality of form data fields;
program code for receiving structured clinical trial data associated with at least one of the plurality of form data fields;
program code for receiving unstructured clinical trial data; and
program code for transmitting the structured clinical trial data and unstructured clinical trial data to the server over the network.

11. The computer-readable medium of claim 10, further comprising:
program code for receiving a request to check out previously entered structured and unstructured data associated with a patient; and
program code for causing the previously entered structured and unstructured clinical trial data to be displayed with the clinical trial form.

12. The computer-readable medium of claim 10, further comprising program code for generating the clinical data form, the structured clinical trial data, and the unstructured clinical trial data in a human-readable.

13. A system comprising:
a client device in communication with a server device over a network;
a clinical trial data capture architecture on the client device, the clinical trial data capture architecture configured to:
receive a clinical trial form on a client device over a network from a server device, the clinical trial form comprising a plurality of form data fields;
receive structured clinical trial data associated with at least one of the plurality of form data fields;
receive unstructured clinical trial data; and
transmit the structured clinical trial data and unstructured clinical trial data to the server over the network.

14. A method comprising:
transmitting a clinical trial form to a client device over a network from a server device, the clinical trial form comprising a plurality of form data fields and a plurality of validation rules;
receiving structured clinical trial data associated with at least one of the plurality of form data fields from the client device;
receiving unstructured clinical trial data associated with the clinical trial form from the client device; and
outputting the structured clinical trial data and unstructured clinical trial data.

15. The method of claim 14, further comprising generating a human-readable document containing the structured and unstructured data.

16. The method of claim 14, wherein the unstructured clinical trial data comprises digital ink.

17. The method of claim 14, wherein the unstructured clinical trial data comprises at least one of a signature or an annotation.

18. The method of claim 14, wherein the client device comprises a tablet PC.

19. The method of claim 14, further comprising generating the clinical data form, the structured clinical trial data, and the unstructured clinical trial data in a human-readable form.

20. The method of claim 19, wherein the human readable form comprises a portable document format (pdf) document.
